(19) United States
(12) Patent Application Publication
(10) Pub. No.: US 2013/0027938 A1
(43) Pub. Date: Jan. 31, 2013

(54) BULB-TYPE LED LAMP

(71) Applicant: Takeshi Hisayasu, Yokosuka-shi (JP)

(72) Inventor: Takeshi Hisayasu, Yokosuka-shi (JP)

(73) Assignee: Toshiba Lighting & Technology Corporation, Kanagawa (JP)

(21) Appl. No.: 13/415,521

(22) Filed: Mar. 8, 2012

(30) Foreign Application Priority Data
Jul. 26, 2011 (JP) 2011-163009

(51) Int. Cl. F21V 21/00

(52) U.S. Cl. 362/249.02

(57) ABSTRACT

An LED lamp includes an LED module, a base body and a cover. The base body includes a contact surface which is thermally coupled to the LED module, and a recess portion. The cover includes a base part that has a fitting tab which is positioned in the recess portion and sandwiched between an outer edge of the LED module and the base body.

### CROSS-REFERENCE TO RELATED APPLICATIONS

This application is based upon and claims the benefit of priority from Japanese Patent Application No. 2011-163009 filed Jul. 26, 2011; the entire contents of which are incorporated herein by reference.

### FIELD

Embodiments described herein relate generally to a bulb-type LED lamp including a cap for a bulb.

### BACKGROUND

With the improvement of luminous efficiency, a light-emitting diode (LED) becomes adopted in a luminaire. Instead of an incandescent lamp using a filament as a light source, a bulb-type LED lamp using an LED as a light source becomes popular. The LED lamp includes a board on which the LED as the light source is mounted, a base body to which the board is fixed, and a globe that covers the board and is attached to the base body. Since the amount of heat generation of the LED is small as compared with the filament, the globe is sometimes formed of a hard synthetic resin. The globe is fitted to the base body after the board is attached, or is bonded by an adhesive.

In order to remove the heat generated by the LED, the base body is made of a material having excellent heat conductivity, for example, aluminum alloy. As long as a special material is not adopted, the linear expansion coefficient of the globe is different from the linear expansion coefficient of the base body. Accordingly, when the globe is bonded and fixed, an adhesive having elasticity, such as silicone adhesive, must be used. Further, in order to absorb a size difference caused by thermal deformation, a certain volume is required. Besides, when the globe is fitted and fastened to the base body, an adhesive is also used to prevent the globe from being easily detached by a light impact.

The LED has a long service life, and the LED lamp is expected to be used for ten or more years. During this period, the adhesive becomes hard due to aging degradation, and further, it is also expected that the deterioration is accelarated due to heat application. Expansion and contraction are repeated by temperature change caused by repeating lighting on and off.

As a result, the deformation is repeatedly applied to the adhesion portion between the globe and the base body, and the adhesive may be peeled or damaged. Besides, if the globe is fastened to the base body by fitting, stress is always applied to the fitting portion by elastic deformation. When the deformation is repeatedly applied to the portion as stated above, the deterioration is accelerated and fatigue breaking is likely to occur.

### BRIEF DESCRIPTION OF THE DRAWINGS

FIG. 1 is a perspective view showing an outer appearance of an LED lamp of an embodiment.

FIG. 2 is an exploded perspective view of the LED lamp shown in FIG. 1.

FIG. 3 is a perspective view of the LED lamp in which a globe base part is fitted to a base body of FIG. 2.

FIG. 4 is a perspective view of the LED lamp in which an LED module is mounted to the base body of FIG. 3.

FIG. 5 is a sectional view of a fitting part of the base body, the globe base part and the LED module shown in FIG. 4.

### DETAILED DESCRIPTION

In general, according to one embodiment, an LED lamp having a structure in which stress due to thermal deformation is hard to be applied to a joint portion between a globe and a base body is provided. The LED lamp of one embodiment includes an LED module, the base body, and the globe. The LED module has at least one LED mounted on a board. The base body includes a contact surface which is thermally connected to the LED module, and a recess portion which is formed in a part of the contact surface inside from an outer diameter of the board. The globe includes a base part which is fixed to the base body at an outside of the contact surface, and a fitting tab which extends from an inner peripheral edge of the base part and is positioned in the recess portion.

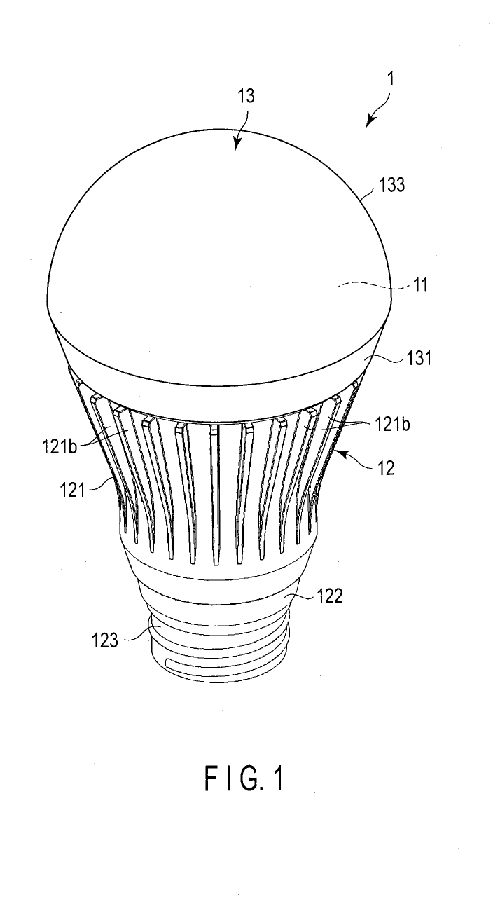

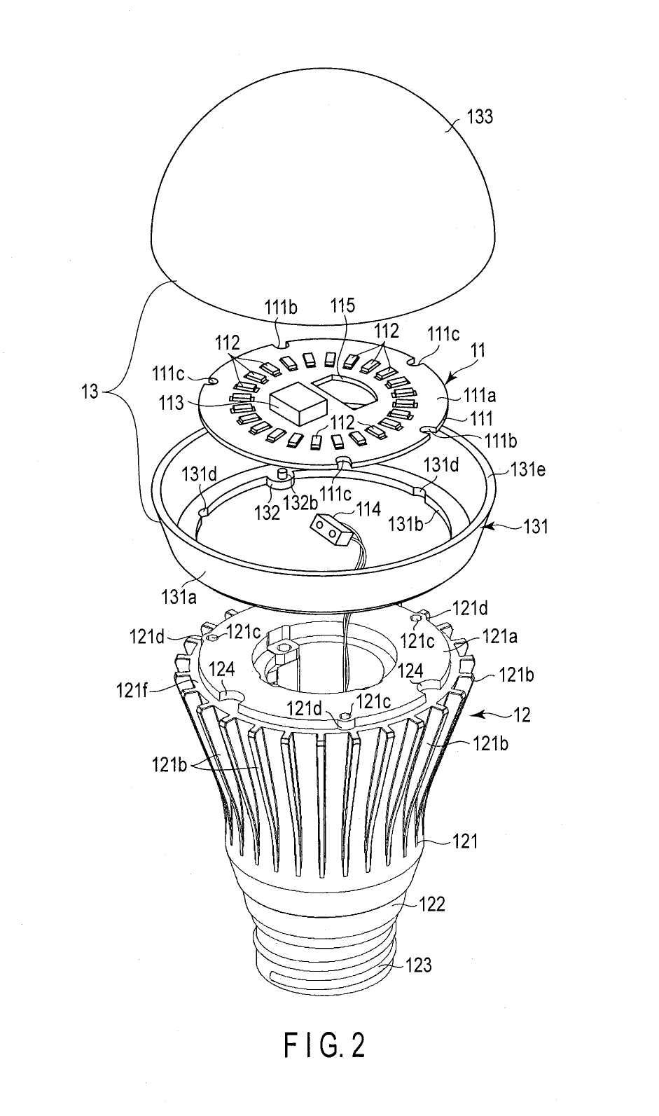

An LED lamp 1 of an embodiment will be described with reference to FIG. 1 to FIG. 5. The LED lamp 1 shown in FIG. 1 is an LED lamp having a so-called bulb-type outer appearance. In the specification, the “LED” includes a light-emitting device in addition to a light-emitting diode. The LED lamp 1 includes an LED module 11 shown in FIG. 2, a base body 12 and a globe 13.

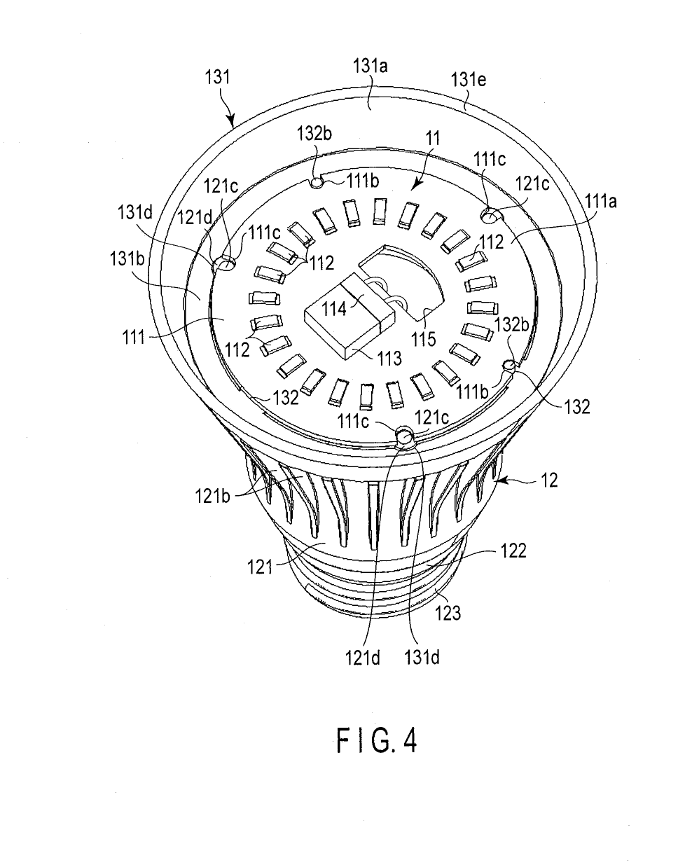

As shown in FIG. 2, the LED module 11 includes a board 111 formed into a circular disk shape, at least one LED 112 mounted on the board, and a connector 113 arranged at a center part of the board 111. In this embodiment, as shown in FIG. 2 and FIG. 4, 24 LEDs 112 are concentrically arranged around the center of the board 111 at equal intervals. The connector 113 is attached to a position inside the LED 112 and eccentric from the center of the board 111. Besides, a hole 115 having a sufficient size to allow a plug 114 connected to the connector 113 to pass through is opened in the center part of the board 111 and in the vicinity of the position where the connector 113 is attached. The plug 114 is connected to a control board arranged inside the base body 12. The control board is provided with a power supply circuit and a lighting circuit.

As shown in FIG. 2, the base body 12 includes a radiator 121, an insulating member 122 and a cap 123. The radiator 121 is a member having excellent heat conductivity, in this embodiment, a die-cast product of aluminum alloy, and includes a contact surface 121a thermally connected to the LED module 11. The contact surface 121a includes an area in contact with the board 111 in a range where the LED 112 is mounted. In this embodiment, the contact surface 121a is an upper surface of a pedestal base having an outer diameter substantially equal to or slightly larger than the outer diameter of the board 111.

The radiator 121 includes fins 121b for heat radiation at equal intervals on the outside surface in order to radiate heat generated by the LED 112. The insulating member 122 is made of a nonconductive member such as synthetic resin, and is inserted and fitted in the inside of the radiator 121. The insulating member 122 holds therein the control board. The cap 123 is formed to conform to a socket for incandescent lamp, and is insulated from the radiator 121 by the insulating member 122. The cap 123 is connected to the control board.

As shown in FIG. 1, the globe 13 is formed into a dome shape, and is attached to cover the LED module 11. The globe 13 includes a base part 131, a fitting tab 132 and a dome part 133.

As shown in FIG. 4, the base part 131 is formed to surround the outer periphery of the LED module 11, and includes a side wall 131a along a conical surface passing the tips of the fins 121b of the radiator 121, and a flange 131b parallel to the contact surface 121a and extending inside. The base part 131 is fastened to the base body 12 at the outside of the contact surface 121a. In this embodiment, the thickness of the flange 131b is substantially equal to or slightly thinner than the height of the pedestal base of the radiator 121. The flange 131b is fastened to an attachment seat 121f formed around the pedestal base by an adhesive having elasticity.

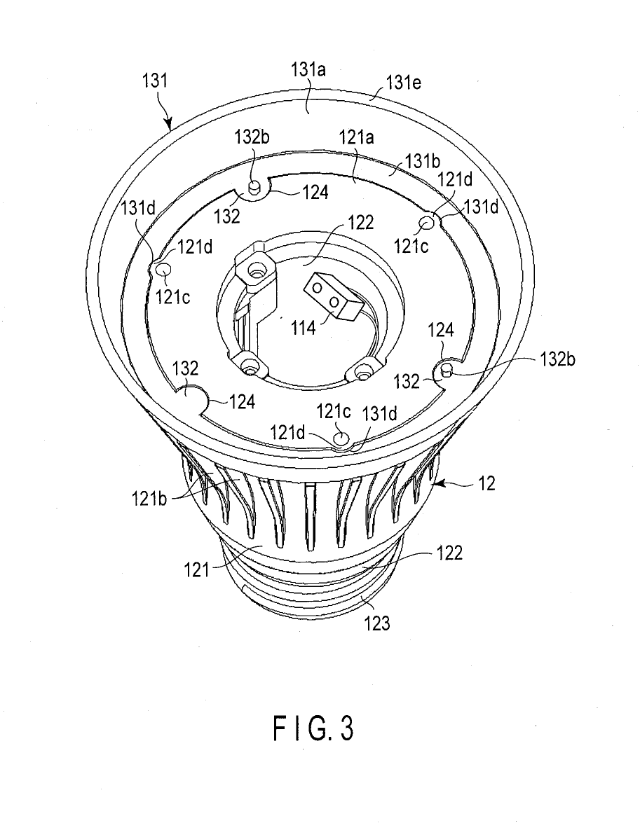

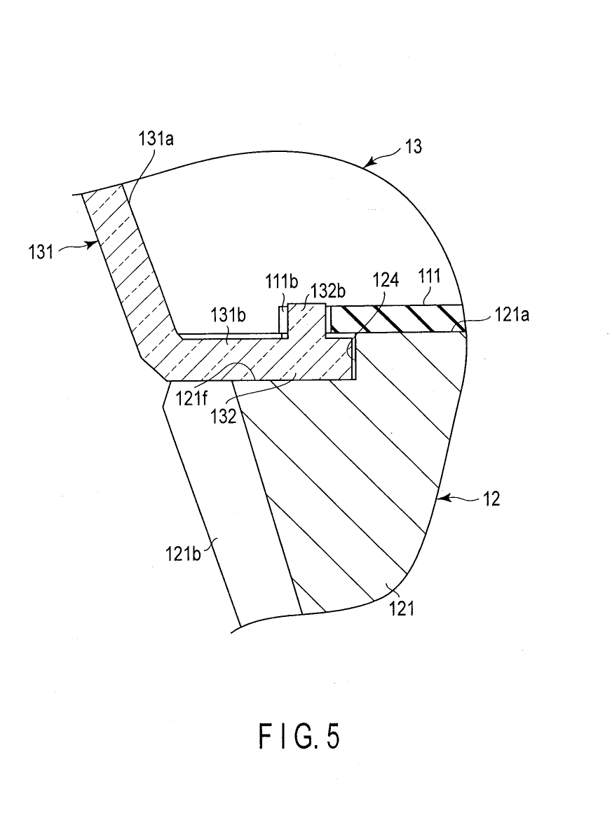

At least one fitting tab 132, in this embodiment, three fitting tabs are prepared at substantially equal intervals, and extend from the inner peripheral edge of the base part 131 along the contact surface 121a so that the fitting tabs extend inside from the outer periphery of the LED module 11. In this embodiment, the fitting tabs 132 extend from the inner peripheral edge of the flange 131b to the inside. The fitting tabs 132 are inserted between an outer edge portion 111a of the board 111 and the base body 12. In this embodiment, as shown in FIG. 2, FIG. 3 and FIG. 5, the fitting tab is inserted into a recess portion 124 formed on the base body 12 side. The recess portion 124 is formed by cutting away a part of the pedestal base formed with the contact surface 121a so that the recess portion has the same height as the attachment seat 121f formed around the pedestal base. The fitting tab 132 is positioned between the board 111 facing the contact surface 121a and the recess portion 124 of the same plane as the attachment seat 121f.

The recess portion 124 is formed by cutting away the contact surface 121a of the radiator 121 in conformity with the fitting tab 132. Besides, the radiator 121 includes holes 121c for screwing the board 111 by a screw at a substantially middle position between the fitting tabs 132 in the circumferential direction of the base part 131. A seat portion 121d extending to the outer peripheral side of the contact surface 121a is formed in order to reinforce the holes 121c. A recess portion 131d is formed in the flange 131b of the base part 131 at a position corresponding to the seat part 121d.

In this embodiment, at a contact part between the base body 12 and the globe 13, as shown in FIG. 3, the recess portions 124 and the seat portions 121d are formed in the radiator 121 of the base body 12 so as to conform to the fitting tab 132 of the globe 13 and the inner peripheral shape of the flange 131b.

A dome part 133 is joined to an edge 131e of the base part 131 on a side opposite to the side where the fitting tab 132 is provided. In this embodiment, the dome part 133 is formed to be substantially hemispherical. According to the material and a manufacturing process of the globe 13 formed of synthetic resin by injection molding, the spherical surface may be a slightly incomplete hemisphere or may be a spherical surface integrally molded to a position exceeding a great circle. The dome part 133 is fusion-joined to the edge 131e of the base part 131 by ultrasonic joining or laser joining.

In the LED lamp 1 constructed as stated above, the assembly is made to the base body 12 in sequence from below shown in the exploded perspective view of FIG. 2. First, as shown in FIG. 3, the base part 131 of the globe 13 is fitted to the radiator 121 of the base body 12. At this time, at least one fitting tab 132 includes a positioning portion 132b protruding in the thickness direction of the board 111. In this embodiment, as shown in FIG. 3, the three fitting tabs 132 are provided, and the positioning portions 132b are formed in two of the fitting tabs.

As shown in FIG. 2 and FIG. 4, the board 111 includes engaged portions 111b in the outer edge portion 111a at a position corresponding to the positioning portions 132b, and includes screwing portions 111c in the outer edge portion 111a at a position corresponding to the holes 121c of the radiator 121. The engaged portions 111b and the screwing portions 111c are notches opening in the outer periphery of the board 111.

As shown in FIG. 4, the board 111 is mounted while the engaged portions 111b are conformed to the positioning portions 132b, and the plug 114 passing through the hole 115 is connected to the connector 113. As screws are attached to the holes 121c, and the LED module 11 is fastened so that the board 111 in the range where the LEDs 112 are mounted is in close contact with the contact surface 121a of the radiator 121, and the LED module is thermally connected to the base body 12.

FIG. 5 shows a positional relation in this state among the recess portion 124 formed in the radiator 121 of the base body 12, the fitting tab 132 of the globe 13, and the outer edge portion 111a of the board 111. As shown in FIG. 5, the fitting tab 132 is formed to be slightly smaller than the size of the recess portion 124 in the thickness direction of the board 111. Accordingly, the board 111 is not separated from the contact surface 121a of the radiator 121 by the insertion of the fitting tab 132 in the recess portion 124 when the board 111 is fastened to the radiator 121. That is, the state where the board 111 is in close contact with the contact surface 121a is maintained.

Besides, as shown in FIG. 5, a gap is provided between the end of the fitting tab 132 close to the inner periphery and the wall of the recess portion 124 close to the inner periphery. Further, the positioning portion 132b provided on the fitting tab 132 and the engaged portion 111b formed in the outer edge portion 111a of the board 111 are fitted to each other with a gap. That is, the globe 13 is not constrained by the board 111 and the radiator 121 by the insertion of the fitting tab 132 in the recess portion 124.

Accordingly, in the LED lamp 1, an excessive stress is not applied to the globe 13, even if a size difference occurs between the radiator 121 of the base body 12 and the base part 131 of the globe 13 by temperature change caused by repeating lighting on and off. As a result, there is no fear that the globe 13 is detached or damaged, even if the LED lamp 1 is used for a long period.

In the LED lamp 1 of the embodiment shown in FIG. 1 to FIG. 5, the board 111 is fastened to the base body 12 at the position other than the positions where the fitting tabs 132 are arranged. On the other hand, the board 111 may be fastened by a screw to the radiator 121 at the position of the fitting tab 132. At this time, the fitting tab 132 includes a hole or a notch through which the screw passes in a state where a gap is provided.

Besides, the globe 13 is joined to the base body 12 by the insertion of the fitting tab 132 in the recess portion 124. Accordingly, in the globe 13, both the movement in the rotation direction along the surface of the board 111 and the movement in the thickness direction of the board 111 are restricted. In order to absorb a size difference caused by a difference between the linear expansion coefficient of the board 111 and the radiator 121 and the linear expansion coefficient of the globe 13, the fitting tab 132 has a gap in the thickness direction and the radius direction of the board 111 with respect to the recess portion 124. The globe 13 is fastened to the base body 12 by an adhesive having elasticity, for example, a silicone adhesive. Accordingly, the gap does not cause the globe 13 to rattle with respect to the base body 12. Even if the adhesive is peeled or cracked due to aging, since the globe 13 sets the fitting tab 132 between the outer edge portion 111a of the board 111 of the LED module 11 and the radiator 121 of the base body 12, the globe is not detached from the base body 12.

The globe 13 of the LED lamp 1 of the embodiment is held by the insertion of the fitting tab 132 in the recess portion 124. On the other hand, the base body 12 and the globe 13 may be coupled in a state where the flange 131b of the base body 131 of the globe 13 is inserted between the outer edge portion 111a of the board 111 and the radiator 121 over the whole periphery. Even if an inadvertent force is applied in the direction of separating the globe 13 from the base body 12, since the globe 13 is held over the whole periphery, the load applied to the screwing portions 111c, the hole 121c and the fitting tab 132 can be relieved.

Incidentally, since the LED lamp 1 of the embodiment is assumed to be used as an illumination apparatus substituting for a related art incandescent lamp, the outer shape is formed into a conical shape expanding from the cap 123 side to the globe 13 side and close to the so-called “bulb shape”. If a luminaire on which an incandescent lamp was mounted is such that a lamp having a shape other than the outer shape of the incandescent lamp can be mounted, the outer shape of the LED lamp 1, especially the outer shape of the radiator 121 may be a cylindrical shape or a polygonal pillar shape other than the shape shown in the drawings, or may be a shape in view of heat radiation characteristics or productivity.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An LED lamp comprising:
an LED module on which at least one light-emitting diode is mounted;
a base body including a contact surface to which the LED module is thermally coupled, and a recess portion that extends inside from an outer periphery of the contact surface; and
a cover including a base part having an inner peripheral edge and a fitting tab extending from the inner peripheral edge and positioned in the recess portion.

2. The LED lamp of claim 1, wherein
the recess portion has a shape that generally conforms to the shape of the fitting tab.

3. The LED lamp of claim 1, wherein
a thickness of the fitting tab is slightly less than a height of the recess portion measured in a thickness direction of the fitting tab.

4. The LED lamp of claim 1, wherein
the LED module is fastened to the base body at a position other than a position where the fitting tab is arranged.

5. The LED lamp of claim 1, wherein
at least one of the fitting tabs includes a positioning portion protruding in a direction of the LED module, and
the LED module includes an engaging portion at a position corresponding to the positioning portion.

6. The LED lamp of claim 5, wherein
the positioning portion and the engaging portion are fitted to each other with a gap therebetween.

7. The LED lamp of claim 1, wherein
the fitting portion has a portion that extends into a gap between an outer edge of the LED module and the base body.

8. The LED lamp of claim 1, wherein
the base body includes heat radiating elements.

9. The LED lamp of claim 8, wherein
the base body further includes a cap adapted for engagement with a socket for a conventional light bulb.

10. The LED lamp of claim 9, wherein
the base body further includes an insulating member between the heat radiating elements and the cap.

11. An LED lamp comprising:
an LED module on which at least one light-emitting diode is mounted;
a base body, thermally coupled to the LED module, for radiating heat generated by the LED module; and
a cover having a dome shape and attached to the base body to cover the LED module, the cover including a base part to surround an outer periphery of the LED module, at least one fitting tab that extends from the base part to a position inside an outer periphery of the LED module and is inserted in a recess portion formed between an outer edge portion of the LED module and the base body, and a dome part connected to an edge of the base part that is opposite to where the fitting tab is provided.

12. An LED lamp comprising:
an LED module on which at least one light-emitting diode is mounted;
a base body including a contact surface to which the LED module is thermally coupled, heat radiating elements for radiating heat generated by the at least one light-emitting diode, and a cap adapted for engagement with a socket for a conventional light bulb; and
a cover including a base part having an inner peripheral edge and a fitting tab extending from the inner peripheral edge and inserted between an outer edge of the LED module and the base body and in a recess formed in the base body.

13. The LED lamp of claim 12, wherein
the recess portion has a shape that generally conforms to the shape of the fitting tab.

14. The LED lamp of claim 13, wherein
the LED module is fastened to the base body at a position other than a position where the fitting tab is arranged.

15. The LED lamp of claim 12, wherein
the cover has a dome-shape.
